(19) United States
(12) Patent Application Publication
(10) Pub. No.: US 2026/0200116 A1
(43) Pub. Date: Jul. 16, 2026

(54) Device and method for transporting and separating blanks of a material web

(71) Applicant: OPTIMA life science GmbH, Schwäbisch Hall (DE)

(72) Inventor: Jochen Bay, Schwäbisch Hall (DE)

(73) Assignee: OPTIMA life science GmbH, Schwäbisch Hall (DE)

(21) Appl. No.: 19/292,647

(22) Filed: Aug. 6, 2025

(30) Foreign Application Priority Data
Aug. 6, 2024 (DE) 102024122364.2

(51) Int. Cl. B26D 7/18; B26F 1/38; B32B 43/00; B65H 5/22; B65H 7/00; H01M 8/1004

(52) U.S. Cl. CPC B26D 7/1863; B26F 1/384; B65H 5/226; B65H 7/00; B32B 43/006; B65H 2301/44336; B65H 2301/51122; B65H 2301/5151; B65H 2406/33; H01M 8/1004

(57) ABSTRACT

The invention relates to a device (100) for transporting and separating blanks (1010) from a material web (1000) with a vacuum cylinder (8) for transporting the blanks (1010), a vacuum transport cylinder (7) for further transporting the blanks (1010), wherein the vacuum cylinder (8) and the vacuum transport cylinder (7) are each equipped with their own independent drive motor (84), and with a control unit (9) to which the drive motor (84) is connected via a data link. According to the invention, speed profiles for the rotation of the vacuum cylinder (8) are stored or can be generated in the control unit (9), and the vacuum cylinder (8) can be rotated with a speed profile with different rotational speeds (R). The invention also relates to a method for transporting and separating blanks from a material web. A device and method enable a gentler and more accurate transfer of blanks from a vacuum cylinder to a vacuum transport cylinder.

### CROSS-REFERENCE TO RELATED APPLICATION

The present application claims priority to German Patent Application No. 102024122364.2, filed Aug. 6, 2024, the entirety of which is incorporated herein by reference.

### DESCRIPTION

The invention relates to a device for transporting and separating blanks from a material web, comprising a vacuum cylinder for transporting the blanks, a vacuum transport cylinder arranged downstream thereof for further transporting the blanks, and a transfer level arranged further downstream for taking over the blanks from the vacuum transport cylinder. The invention also relates to a method for transporting and separating blanks from a material web.

### TECHNICAL FIELD

It is known to manufacture a membrane electrode assembly (MEA) or parts thereof for a fuel cell, an electrolysis cell or a redox flow cell (liquid battery) or membrane-based humidifiers from material webs. The MEA comprises a catalyst-coated membrane (CCM) with edge reinforcements or frames (rims) made of a more cost-effective and resistant material on one or both sides. To further build up the structure, two gas diffusion layers (GDL) can be attached to the outer sides of the MEA. The GDL can be attached in a process that includes the manufacture of the MEA, the CCM and the frame(s), or in a spatially and/or temporally separate process. In another embodiment, an MEA is provided comprising a membrane and two gas diffusion layers arranged thereon, wherein edge reinforcements or frames are attached to one or both sides of this MEA.

In order to position the individual components or blanks of the MEA in relation to each other and connect them, it is known in the prior art to punch individual components from roll material, place them on top of each other, and laminate them. For the MEA to work effectively, the components must be precisely aligned and positioned. It is also important to handle the components as gently as possible, as even small forces acting on catalyst-coated membranes, for example, can cause cracks in the microstructure of the coating.

Furthermore, it is known from the prior art to transport the components of the MEA on vacuum cylinders. The vacuum cylinders are equipped with a porous or perforated surface on their outer walls, through which vacuum is applied. In order to change the distance between components or blanks transported in the material flow on a vacuum cylinder, in particular to increase it, so that they can later be placed down individually and positioned on other components, the components are transferred from a slower rotating vacuum cylinder to a faster rotating vacuum cylinder. At the start of the transfer, a respective blank is mainly sucked in and held by the first vacuum cylinder. In a later phase of the transfer, the blank is mainly sucked in and held by the second vacuum cylinder. The further the transmission process continues, the more the balance of power shifts in favor of the next cylinder. At the point where the suction forces of the second cylinder predominate, the blank is pulled down against the remaining suction force of the first cylinder.

This causes slippage, which leads to position inaccuracy during transmission to the second cylinder. Furthermore, the acceleration behaviour during the slip process cannot be precisely predicted, which also impairs positional accuracy. In the field of MEA manufacturing in particular, there are strict requirements on the accuracy of MEA components that need to be stacked on top of each other.

Another negative side effect is that forces act on the blanks during transfer, which causes elongation in slightly stretchable blanks, namely MEA components, especially the CCM. In other words: The second cylinder pulls at the front end of the blank, while the first cylinder holds the blank back.

The disadvantage of the known solution is therefore that, on the one hand, forces act on the components during transfer from the first to the second vacuum cylinder, which can impair or even damage or destroy them. On the other hand, unwanted slippage occurs between the components and the surfaces of the vacuum cylinders. Due to slippage, the components lose their defined position on the surface of the vacuum cylinders, which impairs subsequent precise positioning relative to other components.

### OBJECT OF THE INVENTION

The object of the present invention is to provide a device for transporting and separating blanks from a material web and a method for transporting and separating blanks from a material web, which enable the blanks to be transferred from a vacuum cylinder to a vacuum transport cylinder with as little slippage as possible and thus more gently and accurately, and which at least partially overcome the disadvantages of the prior art.

### TECHNICAL SOLUTION

This object is solved by a device for transporting and separating blanks from a material web as described and claimed below.

According to the invention, it was recognized as advantageous to operate a vacuum cylinder with a speed profile that has different rotational speeds.

The device is used to transport and separate blanks from a material web, in particular MEA components. The blanks may also be wound dressings, labels, film or membrane blanks, or similar items. The device has a vacuum cylinder for transporting the blanks, a vacuum transport cylinder arranged downstream of this (as viewed in the transport direction of the material web and the blanks) for further transporting the blanks, and a further downstream transfer level for taking over the blanks from the vacuum transport cylinder. Separating blanks describes that they can be placed or transferred individually. If necessary, the distance between two consecutive blanks can also be increased, especially if the blanks are fed directly adjacent to each other without any distance to the vacuum cylinder. According to the invention, the vacuum cylinder and the vacuum transport cylinder are each equipped with their own independent drive motor for their rotational drive. Furthermore, the device has a control unit, wherein at least the drive motor of the vacuum cylinder is connected to the control unit via a data link for controlling the drive motor. Speed profiles for the rotation of the vacuum cylinder are stored in the control unit or can be generated, i.e., calculated. The drive motor of the vacuum cylinder is controlled so that the vacuum cylinder rotates during each revolution with a speed profile with different rotational speeds. In other words: the vacuum cylinder is accelerated, decelerated, or briefly stopped during its rotation. This is allows in an advantageous manner to control slippage when a blank is transferred from the vacuum cylinder to the vacuum transport cylinder and, if needed, to change the distance between two blanks before and after the transfer.

Tests have shown that speed profiles that depend on the surface distribution over the length of a particular blank enable optimized transfer.

In some embodiments, the speed profiles are intended to cause the vacuum cylinder and the vacuum transport cylinder to have the same surface speeds at the start of the transfer of a respective blank and to reduce the rotational speed of the vacuum cylinder as soon as at least 50%, in particular at least 65%, of the surface area of a respective blank has been transferred to the vacuum transport cylinder.

In a further development of the device according to the invention, the device is equipped with a mechanism for feeding a material web for transporting a material web, with a punching cylinder and a counter-punching cylinder for punching blanks from the material web upstream of the vacuum cylinder and/or the vacuum transport cylinder. The punching cylinder is arranged on one side of the material web and the counter-punching cylinder on the other side of the material web in such a way that the material web can pass between them and be punched. Excerpts, i.e., blanks surrounded by a punch residue, are also referred to as blanks here. The material web feeding mechanism, the punching cylinder, and the counter-punching cylinder are each equipped with their own independent drive motor for rotational drive.

According to a first variant, the material web is at least single-layered and has a product layer without a carrier layer, and the vacuum cylinder is formed by the punching cylinder or the counter-punching cylinder. A product layer that is punched by a punching cylinder and a counter-punching cylinder can have several layers. This variant has the advantage of enabling a particularly compact design of the device.

According to a second variant, the material web is multi-layered with at least one carrier layer and one product layer, and the device has a delamination unit for separating the carrier layer from the blanks fixed on the vacuum cylinder. Thanks to the carrier layer, particularly sensitive and/or unstable product layers can be transported and processed. A product layer that is punched by a punching cylinder and a counter-punching cylinder can have several layers.

In both versions, the device can have a mechanism for removing the punching residues and, if necessary, the carrier layer freed from the blanks.

In an advantageous further development of the device, at least the vacuum transport cylinder is equipped with an adhesion-optimized, i.e., adhesion-enhancing surface, such that the surface enables good adhesion of the blanks. This ensures adequate adhesion even if this is not already guaranteed by the material properties of the cylinder surface. The adhesion-enhancing surface ensures that slippage is prevented or at least reduced when the blanks are transferred from the vacuum cylinder to the vacuum transport cylinder. The blanks can thus be transferred without affecting their position.

In a possible embodiment of the device, the transfer level may comprises a circulating conveyor belt or a transport system with product holders for further transporting the blanks, or a product web may be guided in the transfer level, in each case for position-accurate receipt of the blanks from the vacuum transport cylinder. The transport system with product holders can be configured, for example, as a chain with carriers and support trays or as a linear system with movers.

It has been found that it is advantageous to configure the vacuum cylinder in such a way that vacuum is not applied to the entire surface of the jacket. Instead, pressureless segments or segments with overpressure, i.e., regions subjected to blowing air, can be provided. This allows helping to release the blanks from the vacuum cylinder when they are transferred. It is particularly advantageous if the vacuum cylinder has an angular range in which the surface is subjected to vacuum and this angular range is adjustable. In other words, by rotating the angular range around the axis of rotation of the vacuum cylinder, the duration of the vacuum acting on a particular blank can be determined relative to the angle of rotation of the vacuum cylinder. This makes it possible, for example, to ensure that the vacuum acting on a blank in the transfer region, i.e., in the roller gap between the vacuum cylinder and the vacuum transport cylinder, can be terminated sooner or later.

The invention also relates to a method for transporting and separating blanks from a material web as described and claimed below, which can be carried out in particular on a device as described above.

The method is used to transport and separate blanks from a material web, in particular components of an MEA, with the following continuously repeating steps:
a) feeding a material web with blanks
b) transporting the blanks on a vacuum cylinder
c) transferring the blanks to a vacuum transport cylinder and transport of the blanks on the vacuum transport cylinder
d) transferring the blanks to a transfer level
wherein, in step c), the vacuum cylinder is operated with a speed profile that has different rotational speeds and, during the transfer of a respective blank to the vacuum transport cylinder, the rotational speed of the vacuum cylinder undergoes a change, in particular a reduction.

In an advantageous further development of the method, the speed profile is configured such that, at the start of the transfer of a respective blank, the vacuum cylinder and vacuum transport cylinder rotate at the same surface speeds, i.e., when the front edge of a respective blank reaches the transfer region, i.e., the roller gap between the vacuum cylinder and vacuum transport cylinder. This can also be referred to as synchronous operation of vacuum cylinders and vacuum transport cylinders. The speed profile is further configured such that the rotational speed of the vacuum cylinder is reduced as soon as at least 50%, in particular at least 65%, of the surface area of a respective blank has been transferred from the vacuum cylinder to the vacuum transport cylinder and is held by the latter. Since the transfer primarily takes place at constant surface speeds, it is ensured in an advantageous manner that the blanks can be transferred with high positioning accuracy, do not lose their orientation, and do not undergo any stretching. The late reduction in the rotational speed of the vacuum cylinder makes it possible to advantageously vary the distance between two successive blanks without any significant adverse slippage occurring between the blanks and the vacuum cylinder or vacuum transport cylinder.

It is particularly advantageous if the vacuum transport cylinder is moved at a constant rotational speed, as this facilitates particularly precise transfer and positioning of the blanks in the downstream transfer level.

If the circulating conveyor belt located at the transfer level or the product web located at the transfer level moves at a constant speed equal to that of the vacuum transport cylinder, the blanks can be placed thereon with high positional accuracy.

Constant speed does not mean that the speed is unchangeable. Rather, it means that the speed does not change permanently, i.e., there is hardly any acceleration or deceleration, enabling a continuous manufacturing process. If, for example, the speed of the circulating conveyor belt or the product web located in the transfer level is to be increased with the aim of achieving a higher output, or if, for example, due to a necessary roll change or a temporarily slower upstream production plant, the speed of the circulating conveyor belt or the product web located in the transfer level is to be reduced the speeds of the other elements of the device, i.e., vacuum cylinders, vacuum transfer cylinders, etc., must be adjusted accordingly.

In a first variant of the method, an additional step may be provided in further processing before the blanks are transported on a vacuum cylinder: Punching out blanks, in particular by the interaction of a punching cylinder and a counter-punching cylinder, wherein the material web is single-layered and the vacuum cylinder can be formed by the punching cylinder or the counter-punching cylinder.

In a second variant of the method, an additional step may be provided in further processing before the blanks are transported on a vacuum cylinder: Punching out blanks, in particular by the interaction of a punching cylinder and a counter-punching cylinder, wherein the material web is multi-layered with at least one carrier layer and one product layer and, after punching out, delamination takes place to separate the blanks from the carrier layer.

With both method variants, the punching residues and, if necessary, the carrier layer can be removed after punching.

The invention described and the advantageous further developments of the invention described also represent advantageous further developments of the invention in combination with each other, insofar as this is technically feasible.

With regard to further advantages and advantageous embodiments of the invention in terms of construction and function, reference is made to the subclaims and the description of exemplary embodiments with reference to the accompanying figures.

### EXEMPLARY EMBODIMENT

The invention will be explained in more detail with reference to the accompanying figures. Corresponding elements and components are marked with the same reference signs in the figures. For the sake of clarity, the figures are not shown to scale.

The following diagram shows

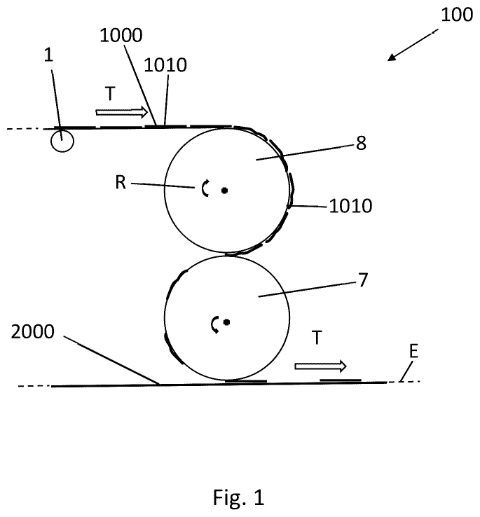

FIG. 1 a first embodiment of a device for transporting and separating blanks

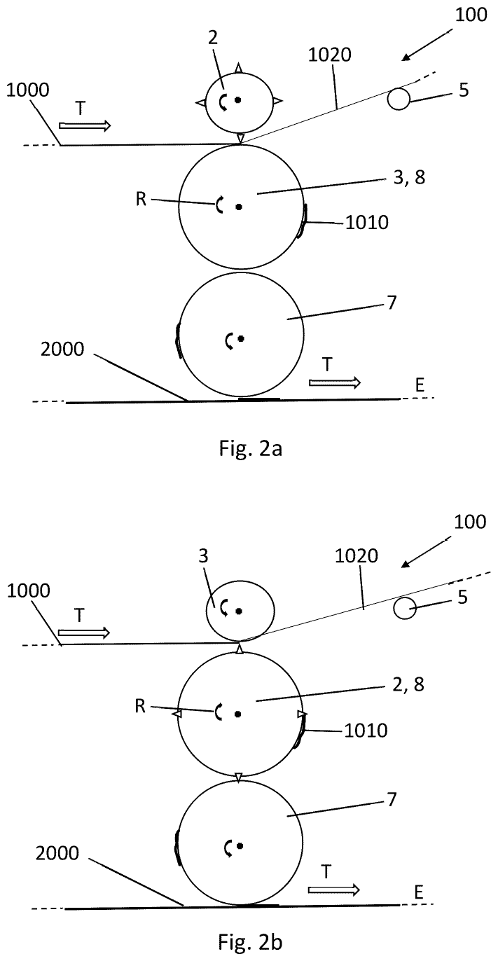

FIGS. 2a and b a second embodiment of a device for transporting and separating blanks of a single-layer material web with two sub-variants

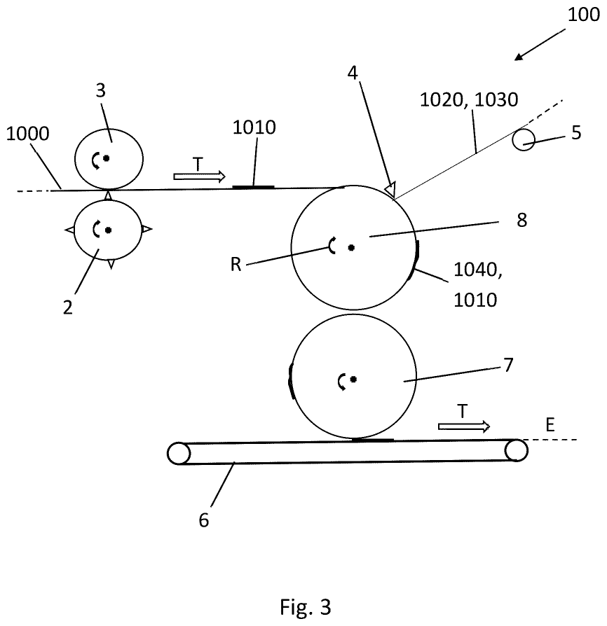

FIG. 3 a third embodiment of a device for transporting and separating blanks from a multi-layer material web

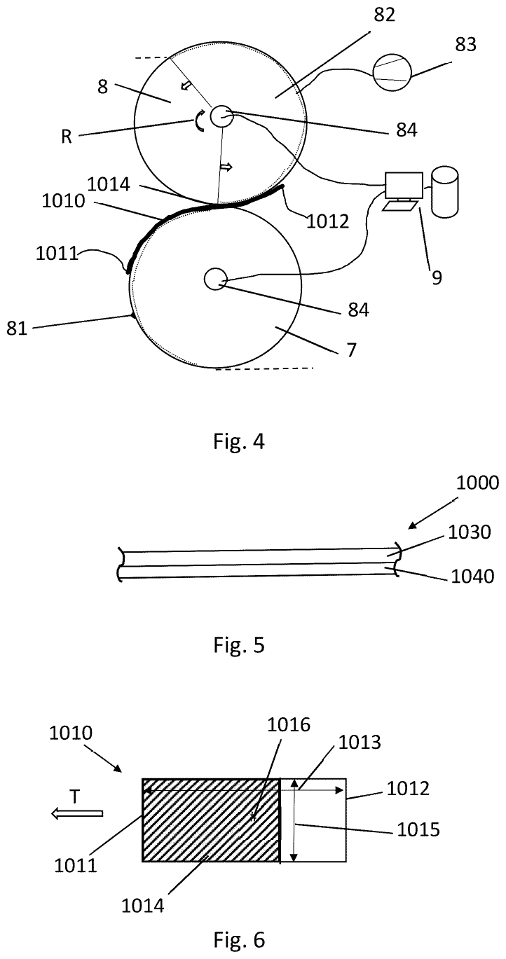

FIG. 4 a detailed view of the vacuum cylinder and the vacuum transport cylinder

FIG. 5 a cross-sectional view of a multi-layer material web

FIG. 6 a blank in a top view.

FIG. 1 shows a first embodiment of a device 100 for transporting a material web 1000 consisting of blanks 1010 arranged in a row and serves to separate the blanks 1010. The device 100 is equipped with a material web feeding mechanism 1 for transporting the material web 1000, a vacuum cylinder 8 for transporting the blanks 1010, a vacuum transport cylinder 7 arranged downstream thereof (as viewed in the transport direction T) for further transporting the blanks 1010, and a transfer level E further downstream for taking over the blanks 1010 from the vacuum transport cylinder 7. Only individual blanks 1010 are shown as examples in the figures. The vacuum cylinder 8 and the vacuum transport cylinder 7 are each equipped with their own independent drive motor 84 (not shown here), and the vacuum cylinder 8 is rotated with a speed profile with different rotational speeds R. Thanks to the speed profile, the transfer of the blanks from the vacuum cylinder 8 to the vacuum transport cylinder 7 can be optimized and the distance between the blanks 1010 is increased. The transfer of blanks 1010 is explained in more detail in FIG. 4. In transfer level E, a product web 2000 is guided to receive the blanks 1010 from the vacuum transport cylinder 7.

FIGS. 2a and b show a second embodiment of a device for transporting and separating blanks from a single-layer material web 1000 in two variants a) and b).

The device 100 is equipped with a punching cylinder 2 and a counter-punching cylinder 3 for punching blanks 1010 from the material web 1000, which are arranged upstream of the vacuum transport cylinder 7. The vacuum cylinder 8 is formed by the counter-punching cylinder 3 in variant a) and by the punching cylinder 2 in variant b) and has its own independent drive motor. For clarity, a material web feeding mechanism 1 is not shown here or in the figure below. Downstream of the punching cylinder 2, a mechanism 5 is arranged for removing the punching residues 1020.

The punching or counter-punching and vacuum cylinder 2 or 3 and 8 is rotated with a speed profile with different rotational speeds R. Thanks to the speed profile, the transfer of the blanks 1010 from the vacuum cylinder 8 to the vacuum transport cylinder 7 can be optimized. The transfer of blanks 1010 is explained in more detail in FIG. 4. In transfer level E, a product web 2000 is guided to receive the blanks 1010 from the vacuum transport cylinder 7.

FIG. 3 shows a third embodiment of a device for transporting and separating blanks, which is similar in design to the device 100 shown in FIG. 2. In contrast, the material web 1000 is multi-layered with at least one carrier layer 1030 and one product layer 1040. Downstream of the punching cylinder 2, the device has a delamination unit 4 for separating the blanks 1010 from the carrier layer 1030.

Furthermore, a mechanism 5 is provided for removing the punching residues 1020 and the carrier layer 1030.

The vacuum cylinder 8 is also rotated here with a speed profile with different rotational speeds R. Thanks to the speed profile, the transfer of the blanks 1010 from the vacuum cylinder 8 to the vacuum transport cylinder 7 can be optimized. The transfer of blanks 1010 is explained in more detail in FIG. 4.

In further contrast to the embodiments described above, the transfer level E has a conveyor belt 6 for further transporting the blanks 1010.

FIG. 4 shows a detailed view of the vacuum cylinder and the vacuum transport cylinder.

As already mentioned above, the vacuum cylinder 8 and the vacuum transport cylinder 7 are each equipped with their own independent drive motor 84, so that the vacuum cylinder 8 can be rotated with a speed profile with different rotational speeds R.

Part of the device 100 is also a control unit 9, with and via which at least the drive motor 84 of the vacuum cylinder 8 is connected for data transmission and can be controlled. Speed profiles for the rotation of the vacuum cylinder 8 are stored or can be generated in the control unit 9, which depend on the length 1013 and/or the surface distribution over the length 1013 of a respective blank 1010, see FIG. 6 for explanation.

The speed profile is such that the same surface speeds of vacuum cylinder 8 and vacuum transport cylinder 7 are achieved at the start of the transfer of a respective blank 1010, i.e., when the front edge 1011 of the blank 1010 is transferred from the vacuum cylinder 8 to the vacuum transport cylinder 7 in the roller gap between the vacuum cylinder 8 and the vacuum transport cylinder 7. The speed profile is further configured such that the rotational speed R of the vacuum cylinder 8 is reduced as soon as at least 50%, in particular at least 65%, of the area 1016 of a respective blank 1010 has been transferred to the vacuum transport cylinder 7.

The vacuum cylinder 8 is equipped with an adhesion-optimized surface 81 to improve the adhesion of the blanks and reduce slippage during transfer between the cylinders.

The vacuum cylinder 8 can have an adjustable angular range 82 in which the outer surface of the vacuum cylinder 8 is subjected to vacuum. As indicated by the double arrows, the angular range 82 can be rotated in its position, but is not enlarged or reduced in size.

FIG. 5 shows a sectional view of a multi-layer material web 1000 with at least one carrier layer 1030 and a product layer 1040, wherein the blanks 1010 can be formed or punched out of the product layer 1040. The product layer 1040 may have several layers, which are not shown here.

FIG. 6 shows a blank in a top view with the dimensions of a blank 1010.

From the front edge 1011 to the rear edge 1012, a blank has a length 1013. The blank 1010 has a width of 1015. The area of the blank, as the product of length 1013 and width 1015, is marked with 1016. A subarea 1014, which occupies ⅔ of the front region of the blank 1010, i.e., more than 65% of its total area, is hatched for clarification.

What is claimed is:

1. A device for transporting and separating blanks from a material web, comprising a vacuum cylinder for transporting the blanks,
a vacuum transport cylinder arranged downstream thereof for further transporting the blanks,
with a further downstream transfer level (E) for taking over the blanks from the vacuum transport cylinder,
wherein the vacuum cylinder and the vacuum transport cylinder are each equipped with their own independent drive motor,
and with a control unit,
wherein the drive motor of the vacuum cylinder is connected to the control unit via a data link,
and speed profiles for the rotation of the vacuum cylinder are stored or can be generated in the control unit, and the vacuum cylinder can be rotated with a speed profile with different rotational speeds (R), in order to accelerate, decelerate, and/or briefly stop the vacuum cylinder in a targeted manner during its rotation.

2. The Device according to claim 1, wherein the speed profiles depend on the area distribution over the length of a respective blank, and/or
wherein the speed profiles cause equal surface speeds of the vacuum cylinder and the vacuum transport cylinder at the start of the transfer of a respective blank and reduce the rotational speed (R) of the vacuum cylinder as soon as at least 50%, in particular at least 65%, of the surface area of a respective blank has been transferred to the vacuum transport cylinder.

3. The device according to claim 1, wherein
the device is equipped with a material web feeding mechanism for transporting a material web, a punching cylinder and a counter-punching cylinder for punching blanks from the material web upstream of the vacuum cylinder and/or the vacuum transport cylinder, and wherein
the material web feeding mechanism, the punching and counter-punching cylinders are each equipped with their own independent drive motor.

4. The device according to claim 3, wherein the material web is single-layered and the vacuum cylinder is formed by the punching cylinder or the counter-punching cylinder.

5. The device according to claim 3, wherein the material web is multi-layered with at least one carrier layer and a product layer and the device has a delamination unit for separating the blanks from the carrier layer.

6. The device according to claim 1, wherein the device has a mechanism for removing the punching residues and, if necessary, the carrier layer.

7. The device according to claim 1, wherein the vacuum transport cylinder is equipped with an adhesion-optimized surface.

8. The device according to claim 1, wherein the transfer level (E) has a conveyor belt or a transport system with product holders for further transporting the blanks or in that a product web is guided in the transfer level (E) to receive the blanks.

9. The device according to claim 1, wherein the vacuum cylinder has an angular range in which the surface of the shell is subjected to vacuum, and this angular range is adjustable.

10. A method for transporting and separating blanks from a material web, comprising the following steps:
a) feeding a material web with blanks
b) transporting the blanks on a vacuum cylinder
c) transferring the blanks to a vacuum transport cylinder and transporting the blanks on the vacuum transport cylinder
d) transferring the blanks to a transfer level (E)
wherein, in step c), the vacuum cylinder is operated with a speed profile that has different rotational speeds (R) and during the transfer of a respective blank to the vacuum transport cylinder, the rotational speed (R) of the vacuum cylinder (8) undergoes a change, in particular a reduction.

11. The method according to claim 10, wherein the speed profile causes equal surface speeds of the vacuum cylinder and the vacuum transport cylinder at the start of the transfer of a respective blank and the rotational speed (R) of the vacuum cylinder is reduced as soon as at least 50%, in particular at least 65%, of the surface area of a respective blank has been transferred to the vacuum transport cylinder.

12. The method according to claim 10, wherein the vacuum transport cylinder is moved at a constant rotational speed (R).

13. The method according to claim 10, with the additional step prior to step b): Punching out blanks, in particular by the interaction of a punching cylinder and a counter-punching cylinder, wherein the material web is single-layered and the vacuum cylinder is formed by the punching cylinder or the counter-punching cylinder.

14. The method according to claim 10, with the additional step prior to step b): Punching out of blanks, in particular by the interaction of a punching cylinder and a counter-punching cylinder, wherein the material web is multi-layered with at least one carrier layer and a product layer and wherein, after punching, delamination takes place to separate the blanks from the carrier layer.

15. The method according to claim 9, wherein after punching, the punching residues and, if necessary, the carrier layer are removed.
